(19) United States
(12) Patent Application Publication
(10) Pub. No.: US 2024/0354549 A1
(43) Pub. Date: Oct. 24, 2024

(54) AUTOMATIC SENSOR DATA VALIDATION ON A DRILLING RIG SITE

(71) Applicant: Schlumberger Technology Corporation, Sugar Land, TX (US)

(72) Inventors: Soumya Gupta, Santa Clara, CA (US); Crispin Chatar, Katy, TX (US); Jose R. Celaya Galvan, Menlo Park, CA (US)

(21) Appl. No.: 18/685,251

(22) PCT Filed: Sep. 21, 2022
(86) PCT No.: PCT/US2022/044176

§ 371 Date: Feb. 21, 2024

Related U.S. Application Data
(60) Provisional application No. 63/261,514, filed on Sep. 23, 2021.

(51) Int. Cl. G06N 3/0442; E21B 44/00

(52) U.S. Cl. CPC G06N 3/0442; E21B 44/00; E21B 2200/22

(57) ABSTRACT

A method automatically validates sensor data. The method includes extracting a sample from a sample time series using a sample window, generating an input vector from the sample, and generating a context vector from the input vector using an encoder model comprising a first recurrent neural network. The method further includes generating an output vector from the context vector by a decoder model comprising a second recurrent neural network and generating a reconstruction error from a comparison of the output vector to the input vector. The reconstruction error indicates an error with the sample. The method further includes presenting the reconstruction error.

### CROSS-REFERENCE TO RELATED APPLICATION

This application claims the benefit of U.S. Provisional Application No. 63/261,514, entitled “AUTOMATIC SENSOR DATA VALIDATION ON A DRILLING RIG SITE,” filed Sep. 23, 2021, the disclosure of which is hereby incorporated herein by reference.

### BACKGROUND

Drilling rigs and wellsites are fitted with various types of instrumentation and sensors. Drilling operators rely on human intervention to handle questionable data from the sensors. With the volume of data being generated on a rig, data validation may be beyond human capacity. A challenge is to handle questionable data and provide data that has been cleaned, corrected, and calibrated.

### SUMMARY

In general, in one or more aspects, the disclosure relates to a method that automatically validates sensor data. The method includes extracting a sample from a sample time series using a sample window, generating an input vector from the sample, and generating a context vector from the input vector using an encoder model comprising a first recurrent neural network. The method further includes generating an output vector from the context vector by a decoder model comprising a second recurrent neural network and generating a reconstruction error from a comparison of the output vector to the input vector. The reconstruction error indicates an error with the sample. The method further includes presenting the reconstruction error.

Other aspects of the disclosure will be apparent from the following description and the appended claims.

### BRIEF DESCRIPTION OF DRAWINGS

FIG. 1, FIG. 2.1, FIG. 2.2, and FIG. 2.3 show systems in accordance with disclosed embodiments.

FIG. 3 shows a flowchart in accordance with disclosed embodiments.

FIG. 4.1, FIG. 4.2, FIG. 4.3, FIG. 4.4, FIG. 4.5, FIG. 4.6, and FIG. 4.7 show examples in accordance with disclosed embodiments.

FIG. 5.1 and FIG. 5.2 show computing systems in accordance with disclosed embodiments.

### DETAILED DESCRIPTION

In general, embodiments of the disclosure relate to identifying anomalies, such as missing data, outliers and sensor drift, etc., using machine learning models. The machine learning models include auto-encoders that include encoder networks and decoder networks that may each include recurrent neural networks (RNNs). The auto-encoders generate reconstruction errors in an unsupervised manner from low dimensional data representations of sensor data form rigs and wellsites.

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being one element unless expressly disclosed, such as by the use of the terms “before”, “after”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For a non-limiting example, two angles may be “about congruent” if the values of the two angles are within ten percent. However, if an engineer determines that the engineering tolerance for a particular product should be tighter, then “about congruent” could be two angles having values that are within one percent. Likewise, engineering tolerances could be loosened in other embodiments, such that “about congruent” angles have values within twenty percent. In any case, the ordinary artisan is capable of assessing what is an acceptable engineering tolerance for a particular product, and thus is capable of assessing how to determine the variance of measurement contemplated by the term “about.”

As used herein, the term “connected to” contemplates multiple meanings. A connection may be direct or indirect. For example, computer A may be directly connected to computer B by means of a direct communication link. Computer A may be indirectly connected to computer B by means of a common network environment to which both computers are connected. A connection may be wired or wireless. A connection may be temporary, permanent, or semi-permanent communication channel between two entities. An entity is an electronic device, not necessarily limited to a computer.

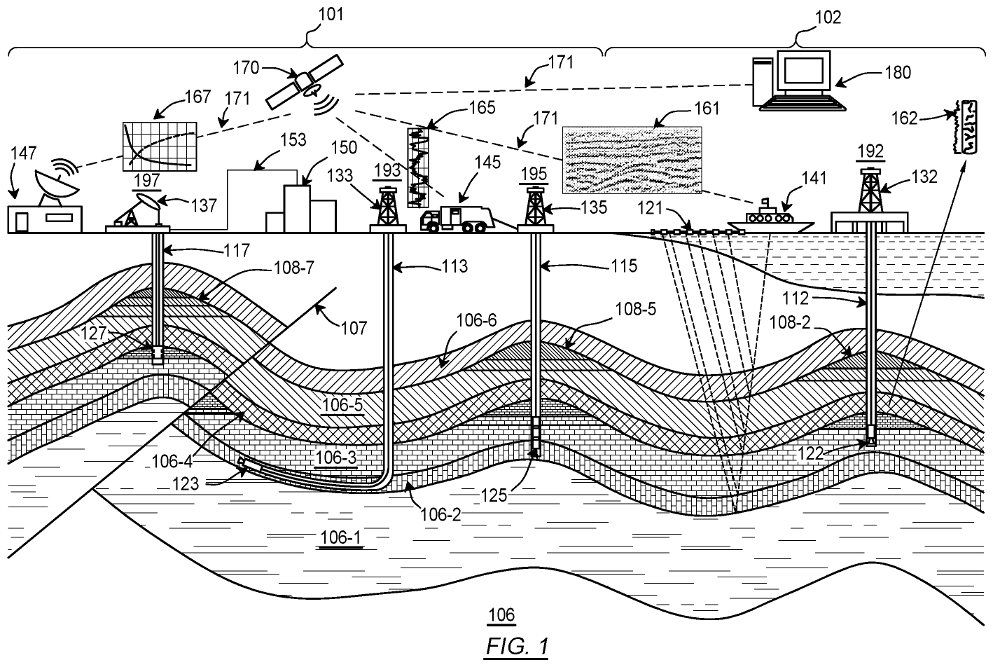

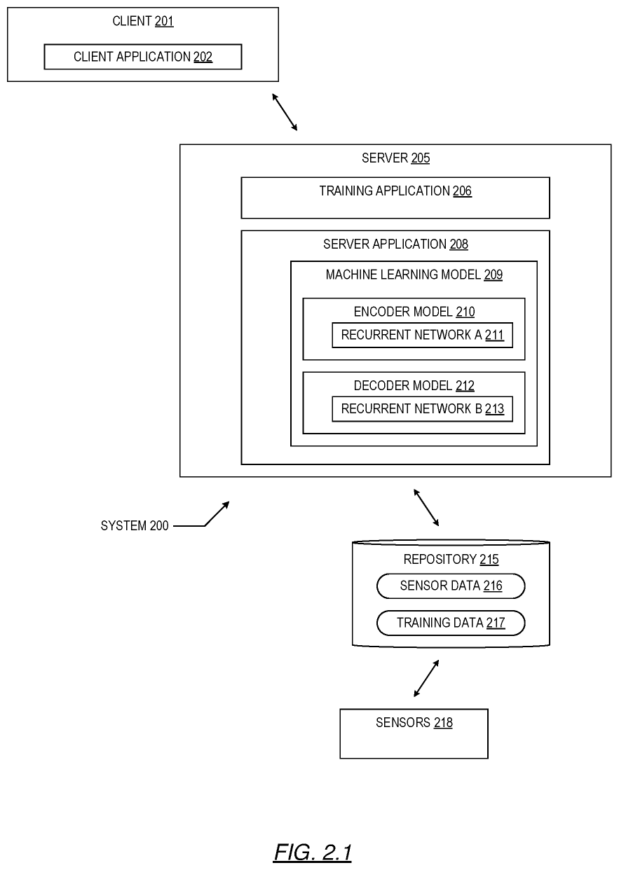

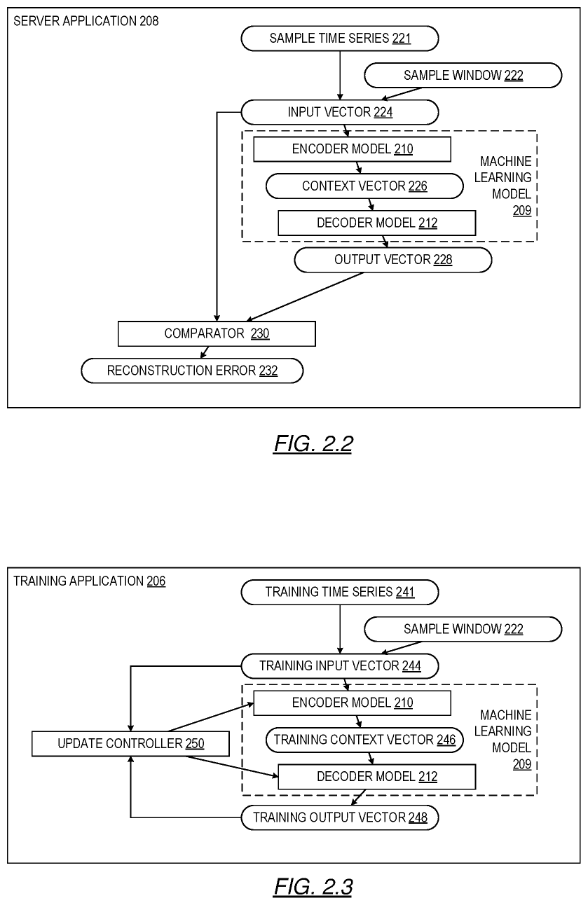

As shown in FIG. 1, the fields (101), (102) include a geologic sedimentary basin (106), wellsite systems (192), (193), (195), (197), wellbores (112), (113), (115), (117), data acquisition tools (121), (123), (125), (127), surface units (141), (145), (147), well rigs (132), (133), (135), production equipment (137), surface storage tanks (150), production pipelines (153), and an exploration and production (E&P) computer system (180) connected to the data acquisition tools (121), (123), (125), (127), through communication links (171) managed by a communication relay (170).

The geologic sedimentary basin (106) contains subterranean formations. As shown in FIG. 1, the subterranean formations may include several geological layers (106-1 through 106-6). As shown, the formation may include a basement layer (106-1), one or more shale layers (106-2, 106-4, 106-6), a limestone layer (106-3), a sandstone layer (106-5), and any other geological layer. A fault plane (107) may extend through the formations. In particular, the geologic sedimentary basin includes rock formations and may include at least one reservoir including fluids, for example, the sandstone layer (106-5). The rock formations may include at least one seal rock, for example, the shale layer (106-6), which may act as a top seal. The rock formations may include at least one source rock, for example, the shale layer (106-4), which may act as a hydrocarbon generation source. The geologic sedimentary basin (106) may further contain hydrocarbon or other fluids accumulations associated with certain features of the subsurface formations. For example, accumulations (108-2), (108-5), and (108-7) associated with structural high areas of the reservoir layer (106-5) and containing gas, oil, water or any combination of these fluids.

Data acquisition tools (121), (123), (125), and (127), may be positioned at various locations along the field (101) or field (102) for collecting data from the subterranean formations of the geologic sedimentary basin (106), referred to as survey or logging operations. In particular, various data acquisition tools are adapted to measure the formation and detect the physical properties of the rocks, subsurface formations, fluids contained within the rock matrix and the geological structures of the formation. For example, data plots (161), (162), (165), and (167) are depicted along the fields (101) and (102) to demonstrate the data generated by the data acquisition tools. Specifically, the static data plot (161) is a seismic two-way response time. Static data plot (162) is core sample data measured from a core sample of any of subterranean formations (106-1 to 106-6). Static data plot (165) is a logging trace, referred to as a well log. Production decline curve or graph (167) is a dynamic data plot of the fluid flow rate over time. Other data may also be collected, such as historical data, analyst user inputs, economic information, and/or other measurement data and other parameters of interest.

The acquisition of data shown in FIG. 1 may be performed at various stages of planning a well. For example, during early exploration stages, seismic data may be gathered from the surface to identify possible locations of hydrocarbons. The seismic data may be gathered using a seismic source that generates a controlled amount of seismic energy. In other words, the seismic source and corresponding sensors (121) are an example of a data acquisition tool. An example of seismic data acquisition tool is a seismic acquisition vessel (141) that generates and sends seismic waves below the surface of the earth. Sensors (121) and other equipment located at the field may include functionality to detect the resulting raw seismic signal and transmit raw seismic data to a surface unit, e.g., the seismic acquisition vessel (141). The resulting raw seismic data may include effects of seismic wave reflecting from the subterranean formations (106-1 to 106-6).

After gathering the seismic data and analyzing the seismic data, additional data acquisition tools may be employed to gather additional data. Data acquisition may be performed at various stages in the process. The data acquisition and corresponding analysis may be used to determine where and how to perform drilling, production, and completion operations to gather downhole hydrocarbons from the field. Generally, survey operations, wellbore operations and production operations are referred to as field operations of the field (101) or (102). These field operations may be performed as directed by the surface units (141), (145), (147). For example, the field operation equipment may be controlled by a field operation control signal that is sent from the surface unit.

Further as shown in FIG. 1, the fields (101) and (102) include one or more wellsite systems (192), (193), (195), and (197). A wellsite system is associated with a rig or a production equipment, a wellbore, and other wellsite equipment configured to perform wellbore operations, such as logging, drilling, fracturing, production, or other applicable operations. For example, the wellsite system (192) is associated with a rig (132), a wellbore (112), and drilling equipment to perform drilling operation (122). A wellsite system may be connected to a production equipment. For example, the well system (197) is connected to the surface storage tank (150) through the fluids transport pipeline (153).

The surface units (141), (145), and (147), may be operatively coupled to the data acquisition tools (121), (123), (125), (127), and/or the wellsite systems (192), (193), (195), and (197). In particular, the surface unit is configured to send commands to the data acquisition tools and/or the wellsite systems and to receive data therefrom. The surface units may be located at the wellsite system and/or remote locations. The surface units may be provided with computer facilities (e.g., an E&P computer system) for receiving, storing, processing, and/or analyzing data from the data acquisition tools, the wellsite systems, and/or other parts of the field (101) or (102). The surface unit may also be provided with, or have functionality for actuating, mechanisms of the wellsite system components. The surface unit may then send command signals to the wellsite system components in response to data received, stored, processed, and/or analyzed, for example, to control and/or optimize various field operations described above.

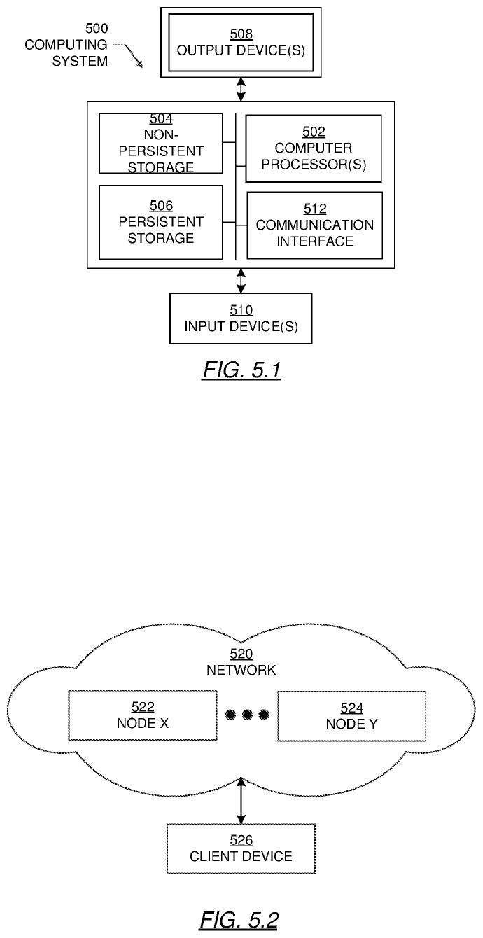

The surface units (141), (145), and (147) may be communicatively coupled to the E&P computer system (180) via the communication links (171). The communication between the surface units and the E&P computer system (180) may be managed through a communication relay (170). For example, a satellite, tower antenna or any other type of communication relay may be used to gather data from multiple surface units and transfer the data to a remote E&P computer system (180) for further analysis. Generally, the E&P computer system (180) is configured to analyze, model, control, optimize, or perform management tasks of the aforementioned field operations based on the data provided from the surface unit. The E&P computer system (180) may be provided with functionality for manipulating and analyzing the data, such as analyzing seismic data to determine locations of hydrocarbons in the geologic sedimentary basin (106) or performing simulation, planning, and optimization of E&P operations of the wellsite system. The results generated by the E&P computer system (180) may be displayed for a user to view the results in a two-dimensional (2D) display, three-dimensional (3D) display, or other suitable displays. Although the surface units are shown as separate from the E&P computer system (180) in FIG. 1, in other examples, the surface unit and the E&P computer system (180) may also be combined. The E&P computer system (180) and/or surface unit may correspond to a computing system, such as the computing system shown in FIGS. 5.1 and 5.2 and described below.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology of machine learning systems. The various elements, systems, components, and blocks shown in the figures may be omitted, repeated, combined, and/or altered as shown from the figures. Accordingly, the scope of the present disclosure should not be considered limited to the specific arrangements shown in the figures.

FIGS. 2.1 through 2.3 show components of computing systems, in accordance with one or more embodiments. The system shown in FIGS. 2.1 through 2.3 is useable with respect to the exploration and production system shown in FIG. 1. Components of the system shown in FIGS. 2.1 through 2.3 may be executed using the computing system and network environment described with respect to FIG. 5.1 and FIG. 5.2.

Turning to FIG. 2.1, the system (200) analyzes subsurface data from a wellsite using the machine learning model (209) for anomalies. The system (200) includes the client (201), the server (205), the repository (215) and the sensors (218).

The client (201) is a computing system that may control and view the results of applying the machine learning model (209) to data from the sensors (218). The client (201) includes the client application (202).

The client application (202) is a program executing on the client (201) to view or control the machine learning model (209) and corresponding results. In one embodiment, the client application may be a web browser that access the server (205).

The server (205) is a computing system that may host the training application (206) and may host the server application (208). The server (205) may be part of a cloud environment and different servers may host the training application (206) and the server application (208).

The training application (206) is a program, which may execute on the server (205). The training application (206) trains the machine learning model (209), which is further described with FIG. 2.3.

The server application (208) is a program, which may execute on the server (205). The server application (208) executes the machine learning model (209).

The machine learning model (209) is program operating on the server (205). In one embodiment, the machine learning model (209) is a recurrent autoencoder that includes the encoder model (210) and the decoder model (212).

The encoder model (210) is a part of the machine learning model (209) that encodes an input to generate a context vector. The context vector generated by the encoder model (210) represents a window of data in a time series of data from one or more of the sensors (218). A context vector may be generated for each window of data from the time series. The system (200) may analyze time series having different lengths. The windows generated by the system (200) form part of a rolling window that converts time series of different lengths into windows of uniform length that are suitable for input to the encoder model (210) and which may overlap. Each context vector may correspond to a distinct window of data in a time series of data. Each window may be defined by a start and end time in the time series. The encoder model (210) includes the recurrent network A (211), which is used to generate a context vector.

The recurrent network A (211) is a part of the encoder model (210). The recurrent network A (211) includes connections between nodes that form a directed graph along a temporal sequence and may use internal states (memory) to process variable length sequences of inputs. In one embodiment, the recurrent network A (211) includes two long short term memory (LSTM) layers.

The decoder model (212) is a part of the machine learning model (209) that decodes the context vector to generate a reconstructed time series. After sufficient training of the machine learning model (209), the reconstructed time series approximately matches the original time series used to generate the context vector decoded by the decoder model (212). The decoder model (212) includes the recurrent network B (213), which is used to generate the reconstructed time series.

After a reconstructed time series is generated with the decoder model (212), the reconstructed time series is compared, by the server application (208), to the original time series to identify the reconstruction error for the reconstructed time series. When the reconstruction error is greater than a threshold, the server application (208) may report (e.g., to the client (201)) that an anomaly exists in the original time series.

The repository (215) is a non-transitory computer readable storage medium which stores a variety of data used by the components of the system (200). The repository (215) includes the sensor data (216) and the training data (217).

The sensor data (216) includes data collected from the sensors (218). The types of data in the sensor data (216) may include data for hook load, revolutions per minute (rev/min), depth, torque, flow, gamma ray detection, etc. Example sensor data is the data described above with reference to FIG. 1.

The training data (217) includes the data used to train the machine learning model (209). The training data (217) may include historical sensor data from the sensors (218).

The sensors (218) are sensors at a well site. The sensors (218) capture data during the drilling of a well to provide data about a well that may include hook load, revolutions per minute (rev/min), depth, torque, flow, gamma ray detection, etc. Example sensors are described above with reference to FIG. 1.

Turning to FIG. 2.2, the server application (208) applies the machine learning model (209) to the sample time series (221) using the sample window (222) to generate the reconstruction error (232). The server application (208) receives the sample time series (221) and selects a subset of the sample time series (221) with the sample window (222) to form the input vector (224).

The input vector (224) is input to the encoder model (210) of the machine learning model (209). The encoder model (210) generates the context vector (226) from the input vector (224) using the recurrent network A (211) (of FIG. 2.1).

The context vector (226) is input to the decoder model (212) of the machine learning model (209). The decoder model (212) generates the output vector (228) from the context vector (226) using a recurrent network B (213) (of FIG. 2.1). The recurrent network B (213) of the decoder model (212) may have the same architecture with different weights as the recurrent network A (211) (of FIG. 2.1) of the encoder model (210).

The output vector (228) represents a reconstruction of the sensor data from the input vector (224) and, correspondingly, a portion of the sample time series (221). After sufficient training, the output vector (228) should generally match the input vector (224) when the input vector (224) does not include anomalies.

The output vector (228) and the input vector (224) are input to the comparator (230). The comparator (230) compares the output vector (228) with the input vector (224) to generate the reconstruction error (232). Different algorithms may be used to generate the reconstruction error (232), including cosine similarity, mean squared error, root mean squared error, absolute error, etc.

Turning to FIG. 2.3, the training application (206) trains the machine learning model (209). The training application (206) generates the training output vector (248) with the machine learning model (209) from the training input vector (244) and updates the machine learning model based on the difference between the training input vector (244) and the training output vector (248).

The training time series (241) is from the training data (217) (of FIG. 2.1). The training time series (241) is historical data that has been previously captured from the sensors (218). The same sample window (222) is used by the training application (206) to selected a subset of the training time series (241) as the training input vector (244).

The training input vector (244) is input to the encoder model (210), which generates the training context vector (246) from the training input vector (244). The training context vector (246) is input to the decoder model (212) to generate the training output vector (248).

The training output vector (248) and the training input vector (244) are input to the update controller (250). The update controller (250) is a program that updates the weights in the encoder model (210) and the decoder model (212) of the machine learning model (209). The update controller (250) may use backpropagation to update the weights of the encoder model (210) and the decoder model (212).

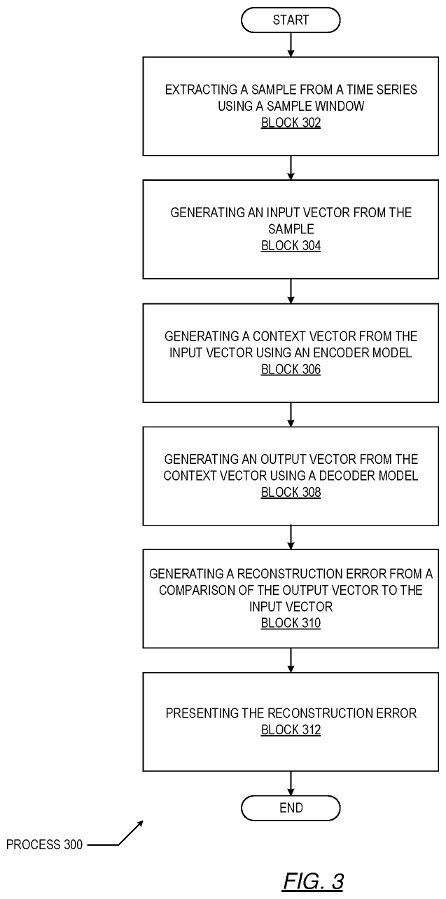

FIG. 3 shows a flowchart of a computer-implemented methods, in accordance with one or more embodiments. The method of FIG. 3 may be executed using the system shown in FIGS. 2.1 through 2.3 in the context of the exploration and production environment shown in FIG. 1. The method of FIG. 3 are flows that are encodable into computer readable program code executable by one or more processors in a networked environment, such as the computing system and network environment shown with respect to FIG. 5.1 and FIG. 5.2.

Turning to FIG. 3, the process (300) automatically validates sensor data from drilling. The process (300) may be performed on a computing system at a well site or in a cloud environment with access to data from the well site.

At Block 302, samples are extracted from a sample time series (also referred to simply as a time series) using a sample window. The sample window identifies the number of values from the time series data to include in a sample. The samples are selected using a rolling window. For example, a time series may include 1,000 data elements, the window size may be 100 data elements, and the stride length (the distance between to start elements of preceding and subsequent windows) may be 1 so that the system generates 901 overlapping windows of data that each include 100 data elements. The samples may be extracted by a server application from a time series stored in a repository. The time series are received form sensors and stored to a repository. In one embodiment, the time series (from which the samples are extracted) includes subsurface data and is received from a set of sensors that generate the time series. The subsurface data may be preprocessed based on values from a slip status, bit on bottom status, and a depth.

At Block 304, input vectors are generated from samples. In one embodiment, the input vector may directly correspond to the sample.

At Block 306, context vectors are generated from the input vectors using an encoder model. The encoder model uses a recurrent neural network to generate the context vectors.

At Block 308, output vectors are generated from the context vectors using a decoder model. The decoder model uses a recurrent neural network to generate the output vectors.

In one embodiment, a machine learning model is trained that includes the encoder model and the decoder model. Training output vectors, generated with the machine learning model, are comparing an input output vector to generate updates to the encoder model and the decoder model. The updates are applied to the encoder model and the decoder model.

In one embodiment, the encoder model may include multiple recurrent layers. An input vector may be input to a first recurrent layer of the recurrent neural network of the encoder model. An output of the first recurrent layer is input to a second recurrent layer of the recurrent neural network of the encoder model. An output of the second recurrent layer is input to a fully connected layer of the encoder model. The context vector, generated by the encoder model, is output from a fully connected layer of the encoder model.

In one embodiment, the first recurrent neural network includes a first long short term memory (LSTM) layer with about 400 neurons and a second LSTM layer with about 200 neurons. The encoder model may include a fully connected layer with about 200 neurons.

In one embodiment, the decoder model may include multiple recurrent layers. The context vector is input to a first recurrent layer of the recurrent neural network of the decoder model. An output of the first recurrent layer is input to a second recurrent layer of the recurrent neural network of the decoder model. An output of the second recurrent layer is input to a fully connected layer of the decoder model. The output vector is output from a fully connected layer of the decoder model.

In one embodiment, the recurrent neural network of the decoder model includes a first long short term memory (LSTM) layer with about 400 neurons and a second LSTM layer with about 200 neurons. The decoder model may also include a fully connected layer with about 200 neurons.

At Block 310, reconstruction errors are generated from a comparison of the output vectors to the input vectors. The reconstruction error between an output vector and an input vector quantifies the dissimilarity between the output vector and the input vector.

At Block 312, reconstruction errors are presented. In one embodiment, the reconstruction error is compared to a threshold. When a reconstruction error meets the threshold, a notification may be generated and presented to a client computing system. In one embodiment, a sensor that includes an error may be identified with the reconstruction error.

In one embodiment, the original data and results may be presented by a client computing system. A first graph of the sample time series may be presented. A second graph of the reconstruction error may be presented. The graphs may be presented together to illustrate where the error is present in the original time series.

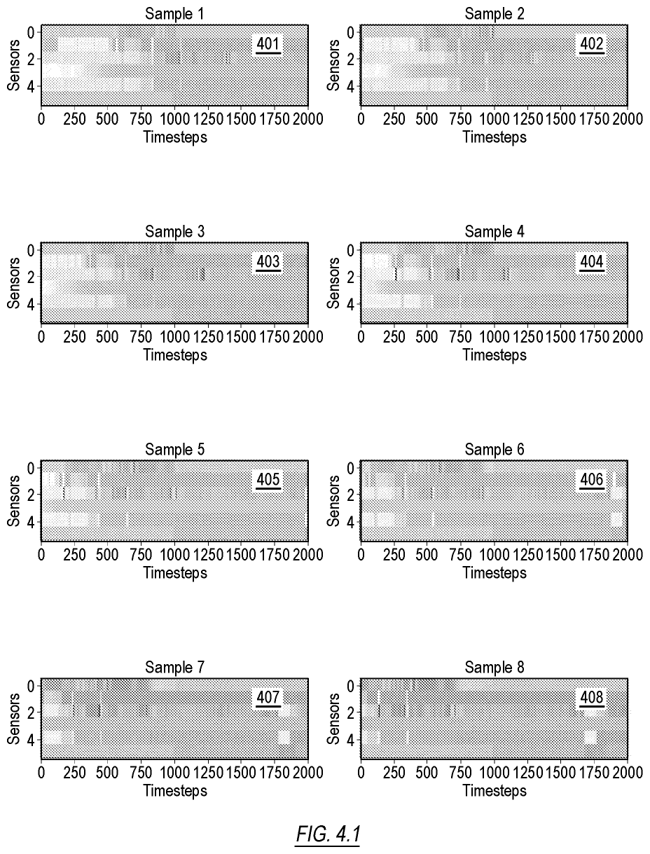

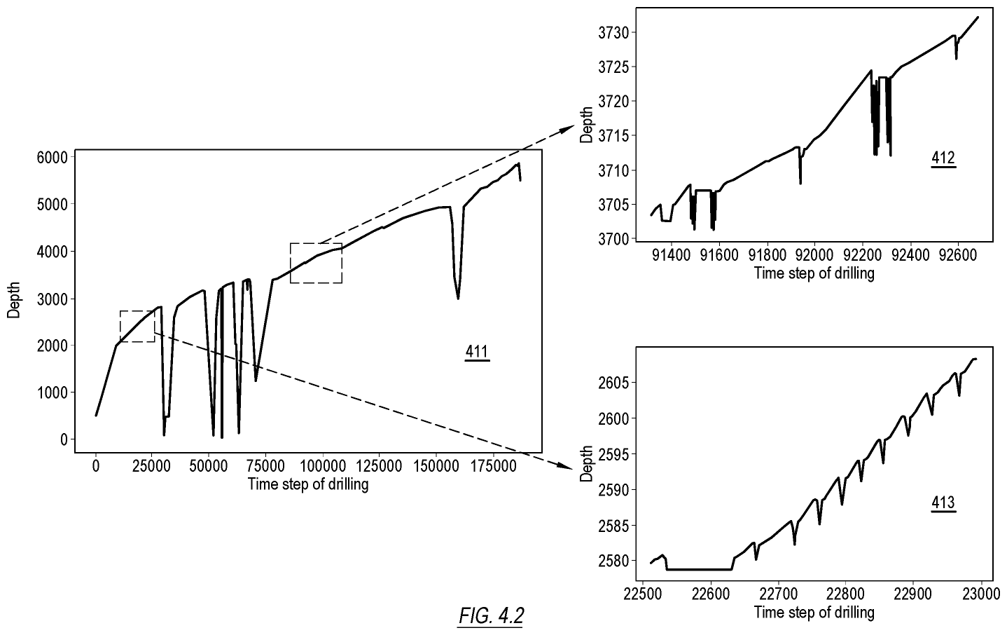

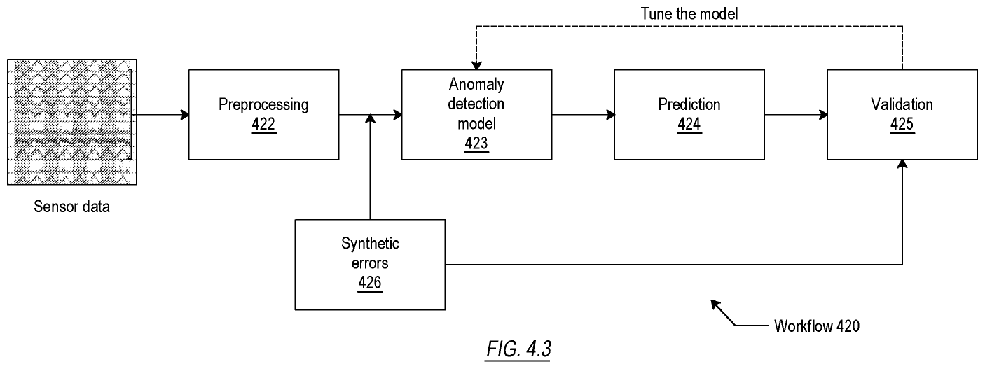

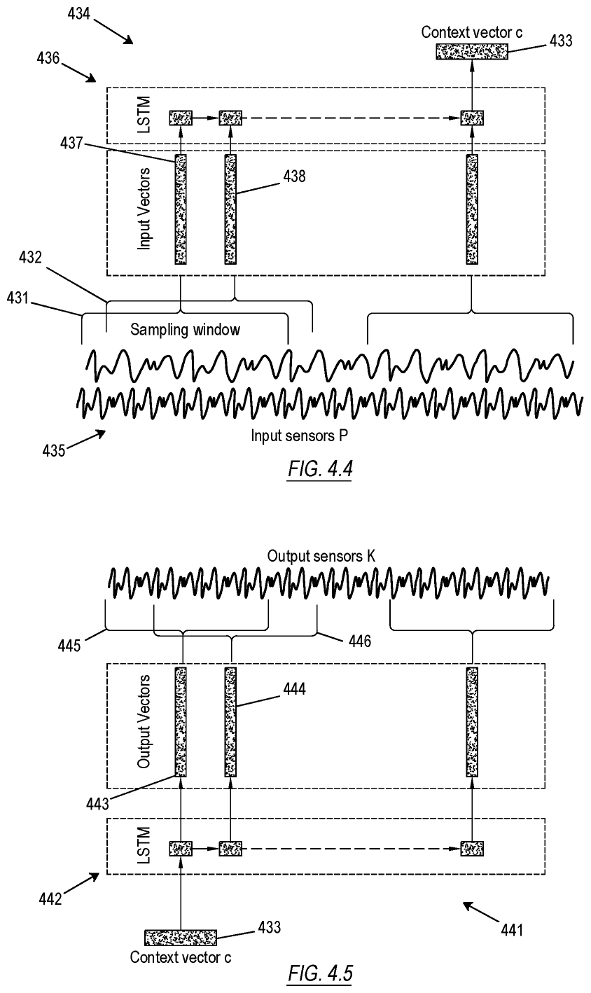

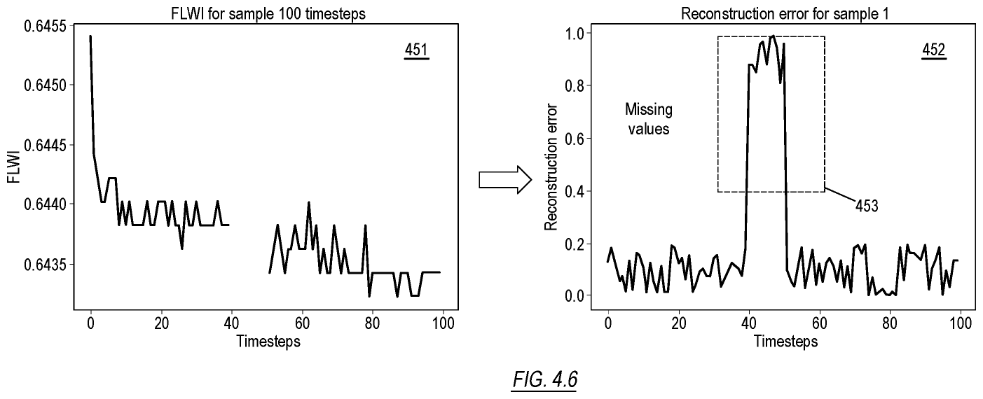

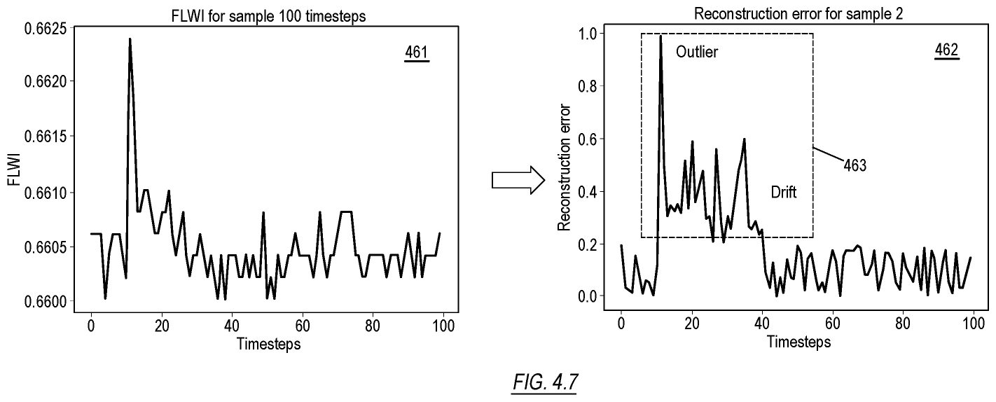

FIG. 4.1 through FIG. 4.7 present specific examples of the techniques described above with respect to FIG. 2.1 through FIG. 3. The following examples are for explanatory purposes and not intended to limit the scope of the one or more embodiments.

Turning to FIG. 4.1, data is collected from thousands of wells across different geographical locations. The drilling rig site may be interpreted as a multidimensional entity that changes with time and contains a P number of sensors with actual data collected from each sensor over time T. A single well system may be defined as Rₜ^{P}:t∈[1,T]. In one embodiment, thousands of systems may be analyzed.

Available data is sparse, sensors are collinear, and observations are auto correlated. The samples 1 (401), 2 (402), 3 (403), 4 (404), 5 (405), 6 (406), 7 (407), and 8 (408) of sensor readings are shown in FIG. 4.1 in which the horizontal axis denotes the time step of the observation and the vertical axis indicates the normalized value of six different sensors. The sensor data includes 8 samples from 6 sensors with data for hook load, revolutions per minute (rev/min), depth sensor, torque, flow, and gamma ray. Different sensors and sensor data may be used.

The data is variable in length. Events of interest (missing data, sensor drift, irregular sensor data, unexpected changes in sensor response, etc.) and are unlabeled and are not identified. From this data, underlying patterns as well as system states are found that help identify anomalies and assist in system diagnostics, which can then be used for sensor validation.

A workflow of the system includes preprocessing the sensor data to prepare the sensor data (also referred to a raw data) for a machine learning task. Data preprocessing improves the quality of the raw data and reduces common errors, including scale bias and missing data, and removes noise that reduces the model performance.

Domain-related data may be preprocessed by extracting the vertical drill pipe stands from the time series data for a given set of sensor data from a well. Data preprocessing removes the noise captured in the sensors when for example, the rig is not drilling. Additionally, preprocessing also narrows the focus of the operation to validating sensors when the systems are working and generating data to avoid sensor data that may be either missing or be of zero value when no drilling operation is being performed at the wellsite.

The algorithm used to extract the vertical stands may use three variables slip status, bit on bottom status, and depth. Slip status is a binary variable that holds information about the drilling slip status being either in-slips (SLIPSTAT=1) or out-of-slips (SLIPSTAT=0). Bit on bottom status is a binary variable that indicates whether the bit is touching the bottom of the well (BONB=1) or if the bit is off-bottom (BONB=0). Depth is a floating point value that contains the information about the depth drilled at a recorded observation point.

To determine the vertical pipe stands, the first step in the workflow is to identify the time periods when the drill string is out of slips and the bit is on bottom. This information indicates if the rig is or is not in a drilling state. The next step is to search for periods where an entire vertical stand is drilled. These periods are identified by calculating depth drilled for each period of time the rig is drilling and match it with the industry standardized vertical stand length (25 m). There are additional common-sense checks added to this algorithm to ensure that the stands extracted are consistent.

Turning to FIG. 4.2, an example of vertical stands extracted from drilling mechanics data for a 6,000-ft well is shown. The plot (411) shows varying depth on the vertical axis with time steps of drilling observations collected on the horizontal axis. Two sample vertical stands are shown in the plots (412) and (413).

Turning to FIG. 4.3, an example workflow (the workflow (420)) is illustrated. The drilling dynamics data may not include labeled anomalies. An unsupervised approach may be used that does not use labels for erroneous instances. An autoencoder, which falls in the unsupervised machine learning category, finds an approximate model that captures the non-defective behavior of the system and the underlying states that a non-flawed system follows. Therefore, an autoencoder model will reconstruct non-defective data when defective data are accepted as input. Anomalies may be identified by analyzing the input imperfect series with reconstructed perfect series. This process enables the calculation of reconstruction error. Setting up a certain threshold for the reconstruction error can help identify these errors. For visualizing the anomaly detection algorithm, synthetic errors are injected into the system, creating the input imperfect time series data. Errors injected are of the types, including, sensor data missing, sensor data present but flat lined, and sensor drift.

The workflow (420) for anomaly detection using a recurrent autoencoder is shown in FIG. 4.3. The raw sensor data (421) sent through the preprocessing (422) to prepare the data for the anomaly detection model. The preprocessing (422) includes the vertical stand extraction and sampling the data. The sampled data from the preprocessing (422) are sent to the anomaly detection model (423). The predictions (424) from the anomaly detection model (423) are compared with the original data, from the preprocessing (422) at the validation (425). The validation (425) may identify sensor errors. The anomaly detection model (423) minimizes the reconstruction error during training. The performance accuracy of the model is used to tune the model to obtain a final trained model. The synthetic errors (426) may be injected into the data from the preprocessing (422).

Turning to FIG. 4.4, the input sensors P generate the time series (435). A sampling window is used to generate samples, including the first sample (431) and the second sample (432). The samples (431) and (432) form the input vectors (437) and (438). The input vectors (437) from the inputs the LSTM (436). The output of the LSTM (436) is used to generate the context vector (433).

Sensor data collected from different wells may be of varying lengths of time. To overcome the varying time length, samples of equal length t are to be generated from the data to be fed into the autoencoder model. For a time series of length T time steps, samples of length t are generated such that t<T, which is done by recursively moving a time window over consecutive time steps.

For example, start at time step 1 and extract a window ending at time step t+1 (e.g., see sample (431)). Then move to time step 2 and extract a window ending at time step t+2 (e.g., see sample (432)) and so on. This method generates equal-length samples from varying lengths of an input time series, and will generate a total of T−t samples from a series of T time steps and window size of length t.

Because the samples are generated by recursively moving the sliding window over the same input data set, the samples may be highly correlated, which is suitable for the recurrent neural network of the autoencoder used by the system. The encoder model (434) of the autoencoder generates the context vector (433) of these samples such that the context vector from each sample itself is highly correlated. This procedure leads to a smooth latent space for the time series data and may generalize more efficiently. Additional visualization such as the T-distributed stochastic neighbor embedding (t-SNE) or principal component analysis (PCA) may be used to visualize this latent space of the context vector (433) and identify the states captured by the outputs of the encoder model (434).

The encoder model (434) encodes the sampled time series (435) into the fixed-length context vector c (433). This sampling process may be carried out over the multiple samples obtained from more than 1,000 data sets. The scheme is to model the underlying states that explain the behavior of the sensors, while ignoring noise in the signal. The recurrent neural network of the encoder model (434) takes care of autocorrelation, which may be observed in the sample due to the rolling window method.

The encoder model (434) uses a long short term memory (LSTM) (436) as the recurrent neural network within the encoder model (434). The LSTM (436) may capture long-term dependencies. In one embodiment, two layers of LSTM may be used, a first LSTM layer with 400 neurons that feeds into a second LSTM layer with 200 neurons. The hyperbolic tangent activation function is used to introduce nonlinearity in the output. The second LSTM layer is followed by a 200-neurons dense layer with linear activation, which acts as the context layer. A dropout of 0.2 is used as a regularization technique to avoid overfitting during training of the encoder model (434).

Turning to FIG. 4.5, the context vector (433) is input to the LSTM (442). The output vectors (443) and (444) are output from the LSTM (442) and form the reconstructed samples (445) and (446). The reconstructed samples (445) and (446) correspond to the original samples (431) and (432) of FIG. 4.4 for the sensors K of the P sensors.

The decoder model (441) operates on the context vector c (433) to recreate data from one the input sensors K. Here, the decoder model (441) is used to recreate data from one target sensor (K) instead of multivariate time series with data for multiple ones of the P sensors. The autoencoder that includes the encoder model (434) (of FIG. 4.4) and the decoder model (441) may be used to reconstruct K (<P) sensors from the P input sensor data. The K sensors are selected from the existing input P sensors. Equations for the encoder model (434) (of FIG. 4.4) and the decoder model (441) may be as follows:

$$Encoder : {R}_{t}^{P} \{ t ∈ [ 0 , T ] \} \to c \qquad ( Eq . 1 )$$

$$Decoder : c \to {R}_{t}^{K} \{ t ∈ [ 0 , T ] \} ; K < P \qquad ( Eq . 2 )$$

The encoder model (434) (of FIG. 4.4) may be used to visualize the each of the available P sensors and decode the K sensors for reconstruction where K may be less than or equal to P. The context vector c (433) captures the states that are relevant to K sensors and removes noise and irrelevant information available in the remainder of the P-K sensors. With the system of FIG. 4.5, K=1, with data for a single sensor being reconstructed. As an example, rev/min may be reconstructed with input sensors that include hook load, flow, torque, depth, gamma rays, etc., as well as rev/min. The decoder model (441) may consider rev/min for reconstruction (without considering the other types of data) while exposing the decoder model (441) to data from each of the P sensors. P is such that the machine learning models may capture P×c context states relevant to each of these sensors.

To decode, the decoder model (441) may use a similar setup to the encoder model, i.e., two LSTM layers. The first LSTM layer with 400 neurons receives the context vector (433) and the second LSTM layer with 200 neurons receives the output from the first LSTM layer. Hyperbolic tangent activation is used to introduce nonlinearity in the system and dropout of 0.2 is used to avoid overfitting. An Adam optimization algorithm may be used to minimize the loss function used to update the weights using backpropagation.

Turning to FIG. 4.6, the graph (451) shows an original time series for a flow sensor (FLWI) with an injected error. The error may be injected artificially to test the system or may be injected by the system due to a hardware issue, a software issue, a drilling issue, etc. The error injected is the removal of values. The graph (452) shows the reconstruction error after comparing the original time series (of the graph (451)) with the reconstructed time series generated by the machine learning model. The box (453) highlights the portion of the graph (452) where the reconstruction error is greater than the threshold. The graphs (451) and (452) may be displayed on a client device.

Turning to FIG. 4.7, the graph (461) shows an original time series for a flow sensor (FLWI) with an injected error. The error may be injected artificially to test the system or may be injected by the system due to a hardware issue, a software issue, a drilling issue, etc. The error injected is an outlier and sensor drift. The graph (462) shows the reconstruction error after comparing the original time series (of the graph (461)) with the reconstructed time series generated by the machine learning model. The box (463) highlights the portion of the graph (462) where the reconstruction error is greater than the threshold. The graphs (461) and (462) may be displayed on a client device.

The machine learning model (which may be referred to as a recurrent autoencoder) reconstructs the original time series (of the graphs (451) of FIGS. 4.6 and (461) of FIG. 4.7) while minimizing a loss function so that the reconstructed time series may accurately match with the original series. The deviation between the original and reconstructed series is captured by the reconstruction error (of the graphs (452) of FIG. 4.6 and (462) of FIG. 4.7). Areas of high reconstruction error indicate deviation from the underlying values and used as an anomaly detection mechanism. A threshold may be set on reconstruction error to identify periods of anomaly. To visualize the performance of the machine learning model, synthetic errors may be injected after preparation of the wellsite data. The reconstruction error is then calculated. FIG. 4.6 shows an example of synthetically removed values in a flow sensor (FLWI) and reconstruction error obtained by analyzing the output sequence from the machine learning model. An example of a synthetically added outlier and sensor drift in the flow sensor and corresponding reconstruction error are shown in FIG. 4.7. The examples shown in FIG. 4.6 and FIG. 4.7 are a few of the many potential errors that may be captured by the machine learning model for a flow sensor. Similar models can be prepared for other sensors such as torque, rev/min, and others. The algorithm used by the machine learning model identifies instances of potential sensor errors.

FIG. 5.1 and FIG. 5.2 are examples of a computing system and a network, in accordance with one or more embodiments. The one or more embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5.1, the computing system (500) may include one or more computer processor(s) (502), non-persistent storage device(s) (504) (e.g., volatile memory, such as random access memory (RAM), cache memory), persistent storage device(s) (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), and numerous other elements and functionalities that implement the features and elements of the disclosure.

The computer processor(s) (502) may be an integrated circuit for processing instructions. For example, the computer processor(s) (502) may be one or more cores or micro-cores of a processor. The computing system (500) may also include one or more input device(s) (510), such as a touchscreen, a keyboard, a mouse, a microphone, a touchpad, an electronic pen, or any other type of input device.

The communication interface (508) may include an integrated circuit for connecting the computing system (500) to a network (not shown) (e.g., a local area network (LAN), a wide area network (WAN) such as the Internet, a mobile network, or any other type of network) and/or to another device, such as another computing device.

Further, the computing system (500) may include one or more output device(s) (512), such as a screen (e.g., a liquid crystal display (LCD), a plasma display, a touchscreen, a cathode ray tube (CRT) monitor, a projector, or other display device), a printer, an external storage, or any other output device. One or more of the output device(s) (512) may be the same or different from the input device(s) (510). The input and output device(s) (510 and 512) may be locally or remotely connected to the computer processor(s) (502), the non-persistent storage device(s) (504), and the persistent storage device(s) (506). Many different types of computing systems exist, and the aforementioned input and output device(s) (510 and 512) may take other forms.

Software instructions in the form of computer readable program code to perform the one or more embodiments may be stored, at least in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform the one or more embodiments.

The computing system (500) in FIG. 5.1 may be connected to or be a part of a network. For example, as shown in FIG. 5.2, the network (520) may include multiple nodes (e.g., node X (522), node Y (524)). A node may correspond to a computing system, such as the computing system (500) shown in FIG. 5.1, or a group of nodes combined may correspond to the computing system (500) shown in FIG. 5.1. By way of an example, the one or more embodiments may be implemented on a node of a distributed system that is connected to other nodes. By way of another example, the one or more embodiments may be implemented on a distributed computing system having multiple nodes, where portions of the one or more embodiments may be located on a different node within the distributed computing system. Further, one or more elements of the aforementioned computing system (500) may be located at a remote location and connected to the other elements over a network.

Although not shown in FIG. 5.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system (500) shown in FIG. 5.1. Further, the client device (526) may include and/or perform the one or more embodiments.

The computing system (500) or group of computing systems described in FIGS. 5.1 and 5.2 may include functionality to perform a variety of operations disclosed herein. For example, the computing system(s) may perform communication between processes on the same or different system. A variety of mechanisms, employing so-me form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the one or more embodiments. The processes may be part of the same or different application and may execute on the same or different computing system.

Rather than or in addition to sharing data between processes, the computing system performing the one or more embodiments may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the one or more embodiments, may extract one or more data items from the obtained data. For example, the extraction may be performed as follows by the computing system (500) in FIG. 5.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (having layers of nodes at different levels of detail—such as in nested packet headers or nested document sections). Then, the raw, unprocessed stream of data symbols is parsed, in the context of the organizing pattern, into a stream (or layered structure) of tokens (where a token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as extensible Markup Language (XML)).

The extracted data may be used for further processing by the computing system. For example, the computing system (500) of FIG. 5.1, while performing the one or more embodiments, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B means comparing the first element of vector A with the first element of vector B, the second element of vector A with the second element of vector B, etc. In one or more embodiments, if A and B are strings, the binary values of the strings may be compared.

The computing system (500) in FIG. 5.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (a database, a table, a record, a column, a view, etc.), identifiers, conditions (comparison operators), functions (e.g., join, full join, count, average, etc.), sorts (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (500) of FIG. 5.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents a few examples of functions performed by the computing system (500) of FIG. 5.1 and the nodes (e.g., node X (522), node Y (524)) and/or client device (526) in FIG. 5.2. Other functions may be performed using one or more embodiments.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

What is claimed is:

1. A method comprising:
extracting a sample from a sample time series (221) using a sample window (221);
generating an input vector (224) from the sample;
generating a context vector (226) from the input vector (224) using an encoder model (210) comprising a first recurrent neural network (211);
generating an output vector (228) from the context vector (226) by a decoder model (212) comprising a second recurrent neural network (213);
generating a reconstruction error (232) from a comparison of the output vector (228) to the input vector (224), wherein the reconstruction error (232) indicates an error with the sample; and
presenting the reconstruction error (232).

2. The method of claim 1, further comprising:
receiving the sample time series (221), comprising subsurface data, from a set of sensors (218) generating the sample time series (221), wherein the subsurface data is preprocessed using a slip status, bit on bottom status, and a depth.

3. The method of claim 1, further comprising:
identifying a sensor (218) comprising an error using the reconstruction error (232).

4. The method of claim 1, further comprising:
training a machine learning model (209) comprising the encoder model (210) and the decoder model (212) by:
comparing a training output vector (248) to a training input vector (244) to generate updates to the encoder model (210) and the decoder model (212); and
updating the encoder model (210) and the decoder model (212) with the updates.

5. The method of claim 1, further comprising:
inputting the input vector (224) to a first recurrent layer of the first recurrent neural network (211);
inputting an output of the first recurrent layer of the first recurrent neural network (211) to a second recurrent layer of the first recurrent neural network (211);
inputting an output of the second recurrent layer of the first recurrent neural network (211) to a fully connected layer of the encoder model (210); and
outputting the context vector (226) from the fully connected layer of the encoder model (210).

6. The method of claim 1, wherein the first recurrent neural network (211) comprises a first long short term memory (LSTM) layer with about 400 neurons and a second LSTM layer with about 200 neurons, and wherein the encoder model (210) comprises a fully connected layer with about 200 neurons.

7. The method of claim 1, further comprising:
inputting the context vector (226) to a first recurrent layer of the second recurrent neural network (213);
inputting an output of the first recurrent layer of the second recurrent neural network (213) to a second recurrent layer of the second recurrent neural network (213);
inputting an output of the second recurrent layer of the second recurrent neural network (213) to a fully connected layer of the decoder model (212); and
outputting the output vector (228) from the fully connected layer of the decoder model (212).

8. The method of claim 1, wherein the second recurrent neural network (213) comprises a first long short term memory (LSTM) layer with about 400 neurons and a second LSTM layer with about 200 neurons, and wherein the decoder model (212) comprises a fully connected layer with about 200 neurons.

9. The method of claim 1, further comprising:
comparing the reconstruction error (232) to a threshold.

10. The method of claim 1, further comprising:
presenting a first graph of the sample time series (221); and
presenting a second graph of the reconstruction error (232).

11. A system (500) comprising:
one or more processors (502);
an application (208) executing on the one or more processors (502) and configured for:
extracting a sample from a sample time series (221) using a sample window (221);
generating an input vector (224) from the sample;
generating a context vector (226) from the input vector (224) using an encoder model (210) comprising a first recurrent neural network (211);
generating an output vector (228) from the context vector (226) by a decoder model (212) comprising a second recurrent neural network (213);
generating a reconstruction error (232) from a comparison of the output vector (228) to the input vector (224), wherein the reconstruction error (232) indicates an error with the sample; and
presenting the reconstruction error (232).

12. The system of claim 11, wherein the application is further configured for:
receiving the sample time series (221), comprising subsurface data, from a set of sensors (218) generating the sample time series (221), wherein the subsurface data is preprocessed using a slip status, bit on bottom status, and a depth.

13. The system of claim 11, wherein the application is further configured for:
identifying a sensor (218) comprising an error using the reconstruction error (232).

14. The system of claim 11, wherein the application is further configured for:
training a machine learning model (209) comprising the encoder model (210) and the decoder model (212) by:
comparing a training output vector (248) to a training input vector (244) to generate updates to the encoder model (210) and the decoder model (212); and
updating the encoder model (210) and the decoder model (212) with the updates.

15. A computer program product (506) comprising computer readable program code for causing a computer system (500) to perform a method comprising:
extracting a sample from a sample time series (221) using a sample window (221);
generating an input vector (224) from the sample;
generating a context vector (226) from the input vector (224) using an encoder model (210) comprising a first recurrent neural network (211);
generating an output vector (228) from the context vector (226) by a decoder model (212) comprising a second recurrent neural network (213);
generating a reconstruction error (232) from a comparison of the output vector (228) to the input vector (224), wherein the reconstruction error (232) indicates an error with the sample; and
presenting the reconstruction error (232).
